(19) United States
(12) Patent Application Publication
(10) Pub. No.: US 2006/0001935 A1
(43) Pub. Date: Jan. 5, 2006

(54) VOA control

(75) Inventor: Jonathan Stuart Drake, Paignton (GB)

Correspondence Address: SUGHRUE MION, PLLC, 2100 PENNSYLVANIA AVENUE, N.W., SUITE 800, WASHINGTON, DC, 20037, US

(73) Assignee: BOOKHAM TECHNOLOGY, PLC.

(21) Appl. No.: 11/099,501

(22) Filed: Apr. 6, 2005

Related U.S. Application Data
(60) Provisional application No. 60/559,427, filed on Apr. 6, 2004.

(51) Int. Cl. G03H 1/00

(52) U.S. Cl. 359/13

(57) ABSTRACT

A method of operating a variable optical attenuator, including producing an error signal indicative of the product of the reciprocal of the actual input power or actual output power and the difference between the actual output power and the target output power; and controlling the attenuator on the basis of the error signal.

### FIELD OF THE INVENTION

The present invention relates to techniques for controlling a variable optical attenuator (VOA).

### BACKGROUND OF THE INVENTION

Variable optical attenuators are used, for example, in optical amplifier products to compensate for span loss variations and to enable the use of variable gain amplifiers whilst maintaining flat optical spectral gain. Proportional-integral (PI) control can be used to compensate for any disturbances.

A typical PI control loop is based on error signals indicative of the difference between the actual optical output power and the target optical output power.

### SUMMARY OF THE INVENTION

One aspect of the present invention is based on the observation that PI control loops based on such error signals can be relatively slow to stabilise at relatively low optical input powers, and it is one aim of the present invention to provide an improved technique for controlling a VOA.

It is an independent aim of the present invention to provide a technique of improving the dynamic range of a VOA control method for both the optical input and outputs.

According to one aspect of the present invention there is provided a method of operating a variable optical attenuator, including producing an error signal indicative of the product of the reciprocal of the actual input power or actual output power and the difference between the actual output power and the target output power; and controlling the attenuator on the basis of the error signal.

According to another aspect of the present invention there is provided a method of operating a variable optical attenuator so as to maintain a target optical power ratio in response to any disturbances; wherein the method includes producing an error signal indicative of the product of the reciprocal of Pin and the difference between Pout and the product of Pin and the target output/input power ratio; and controlling the attenuator on the basis of the error signal.

According to another aspect of the present invention there is provided a system for automatically operating a variable optical attenuator; including an output photodiode optically coupled to the optical output of the VOA, and optionally an input photodiode coupled to the optical output of the VOA; and circuitry for producing on the basis of the outputs from the photodiodes an error signal indicative of the product of the reciprocal of the actual input power or actual output power and the difference between the actual output power and the target output power, and controlling the attenuator on the basis of the error signal.

According to another aspect of the present invention there is provided a system for automatically operating a variable optical attenuator so as to maintain a target optical power ratio in response to any disturbances; including first and second photodiodes coupled to the optical input and outputs of the variable optical attenuator; and circuitry for producing on the basis of the outputs from the photodiodes an error signal indicative of the product of the reciprocal of Pin and the difference between Pout and the product of Pin and the target output/input power ratio, and controlling the attenuator on the basis of the error signal.

According to another aspect of the present invention there is provided a method of operating a variable optical attenuator so as to maintain a target optical power ratio in response to any disturbances; wherein the method includes producing an error signal dependent on the difference between the actual optical power ratio and the target optical power ratio but independent of the absolute value of the input power; and controlling the attenuator on the basis of the error signal.

According to another aspect of the present invention there is provided a system for operating a variable optical attenuator; including photodiodes for receiving a portion of the optical input and output, respectively, of the variable optical attenuator; switchable gain transimpedance amplifiers for receiving the output signals from the photodiodes; and circuitry for controlling the attenuator on the basis of the output signals from the transimpedance amplifiers; wherein said circuitry also automatically controls the gain of the switchable gain transimpedance amplifiers according to the output signals from the transimpedance amplifiers.

The target output/input power ratio refers to the desired ratio of output optical power to input optical power.

### BRIEF DESCRIPTION OF THE DRAWINGS

Embodiments of the present invention will now be described hereunder, by way of example, only with reference to the accompanying drawings, in which:

FIG. 1 is a schematic view of a VOA control system according to a first embodiment of the present invention;

FIG. 2 is a schematic view of a VOA control system according to a second embodiment of the present invention; and

FIG. 3 explains the production of an error signal according to an embodiment of the technique of the present invention.

### DESCRIPTION OF PREFERRED EMBODIMENTS

A VOA control system according to a first embodiment of the present invention includes photodiodes 4, 6 for receiving portions of the optical output and inputs of the VOA 2. The current signals from the photodiodes are converted into corresponding analogue voltage signals by transimpedance amplifiers 8, 10, which are in turn converted into corresponding digital signals A and B by analogue/digital convertors 12, 14. The digital signals A and B from the ADCs are input into a microprocessor 16, which periodically at fixed time intervals produces error signals based on the instantaneous values of signals A and B according to the algorithm below.
[A−(B×Target Output/Input Power Ratio)]/B

The photodiode characteristics (including the proportion of the optic signal received at the photodiode) and the transimpedance amplifier characteristics are the same for both the optical input and output, such that digital signals A and B are in proportion to the output and input optical powers, respectively, by the same constant of proportionality, and the error signal is thus indicative of
[Pout−(Pin×Target Output/Input Power Ratio)]/Pin

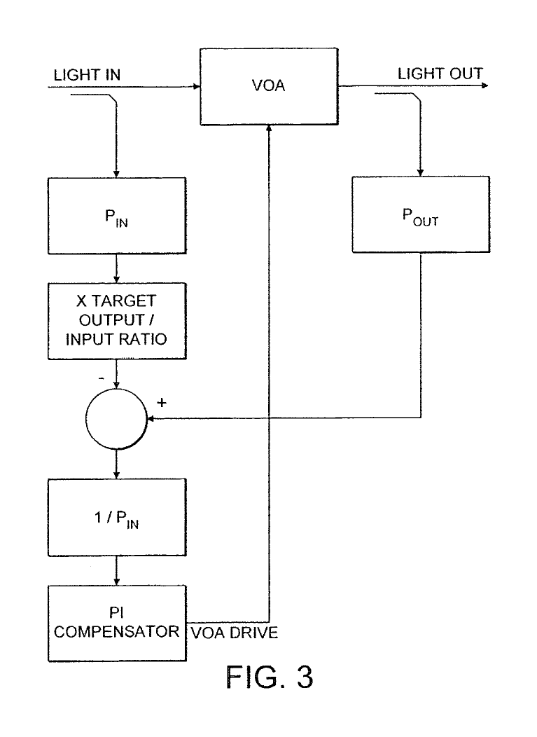

The production of an error signal indicative of [Pout−(Pin×Target Output/Input Power Ratio)]/Pin is further explained by FIG. 3.

The microprocessor then controls the VOA on the basis of the error signals according to a proportional-integral (PI) control method. In detail, the PI control output, which is indicative of a compensated output/input power ratio calculated on the basis of the error signals to achieve the target output/input power ratio, is then converted into an appropriate voltage signal for the VOA, either by an algorithm (where the PI output and the corresponding VOA input voltage signal can be so related) or by the use of a look-up table (possibly with linearised interpolation). The latter is useful, for example, to effectively deal with non-linearities between the log of the PI output (which log is indicative of the compensated attenuation in dB) and the corresponding VOA input voltage signal. This conversion can be carried out in the same microprocessor 16 used to produce the PI control output or in a separate controller located between the microprocessor 16 and the VOA 2.

The error signal is constant for a given difference between actual and target power ratios regardless of the absolute value of the input optical power. Accordingly, with a control loop based on such an error signal the gain margin does not have to be made relatively large for relatively low input powers to ensure a stable loop at relatively high input powers, and because of the flat gain margin the control loop is operable at the same speed regardless of the absolute magnitude of the input/output powers. Moreover, since the technique of producing the error signal avoids the use of logarithmic functions (which generally require large floating point functions or large look-up tables for their implementation), the technique is computationally efficient.

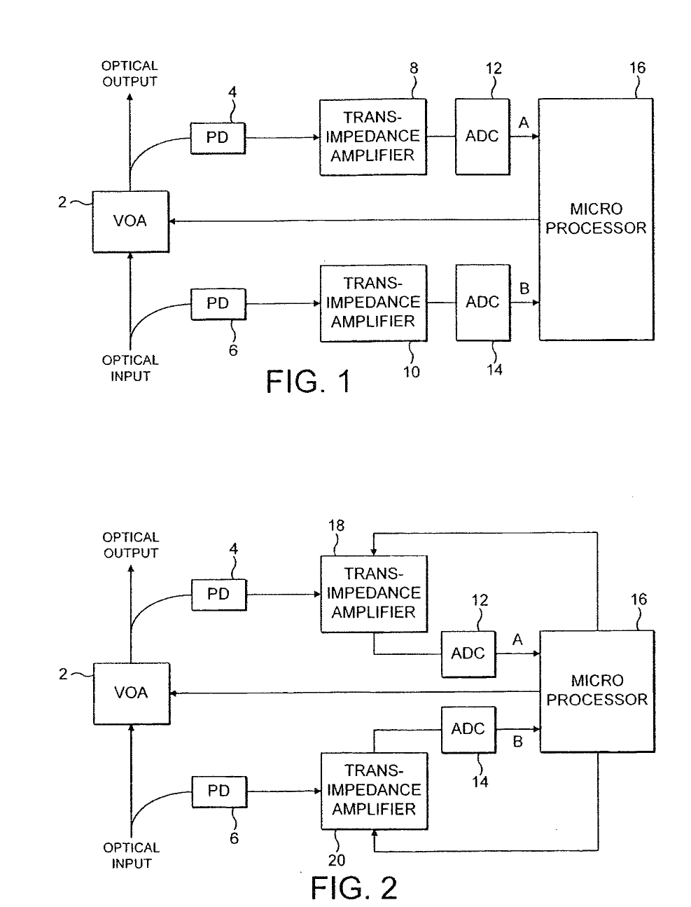

The second embodiment of the present invention as shown in FIG. 2 is the same as that shown in FIG. 1 except that the transimpedance amplifiers 18, 20 are switchable gain transimpedance amplifiers, and the microprocessor 16 controls the gain of the transimpedance amplifiers on the basis of the digital signals (A and B) and in accordance with the resolution of the analogue digital convertors 12, 14. A relatively large input and output dynamic range can thus be achieved with analogue digital convertors of relatively low resolution (i.e. analogue digital convertors with a relatively small number of quantisation levels).

As mentioned above, the embodiments shown in the Figures and described in detail above are only examples of how the invention could be carried out, and a number of modifications are possible without departing from the scope of the invention. For example, the following modifications are possible.

(a) Analogue circuitry could be used instead of the microprocessor to produce the error signals and/or control the attenuator on the basis of the error signals. For example, such analogue circuitry could include transimpedance amplifiers for producing analogue voltage signals A and B indicative of the outputs from the output and input photodiodes respectively; an attenuator for producing an analogue voltage signal C indicative of the product of signal B and the target output/input power ratio; a differential amplifier for producing an analogue voltage signal D indicative of the difference between signals A and C; and a divider chip for producing an analogue voltage signal (error signal) indicative of signal D divided by signal B.

(b) The technique of improving the dynamic range for a given analogue-digital convertor resolution is not limited to digital VOA control techniques that use analogue-digital convertors; they are also applicable to analogue control techniques where analogue circuitry downstream of the transimpedance amplifiers has a relatively limited linear range.

(c) The technique of the present invention is also of use where the input power is expected to be substantially constant, and the aim is to achieve a target output power. Then, for a given ratio between the input power and the target output power, producing an error signal indicative of the product of the reciprocal of the actual or target output power and the difference between the target output power and the actual output power will be the same for any given disturbance regardless of the absolute magnitude of the input power. Thus the system can be switched from relatively high powers (e.g. an input power of 80 mW and a target output power of 20 mW) to relatively low powers (e.g. an input power of 4 mW and a target output power of 1 mW), and the error signal will be nevertheless be the same for a given disturbance. In this application, the input photodiode is optional where the error signal is indicative of the product of the reciprocal of the target output power and the difference between the actual output power and the target output power.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

What is claimed is:

1. A method of operating a variable optical attenuator, including producing an error signal indicative of the product of the reciprocal of the actual input power or actual output power and the difference between the actual output power and the target output power; and controlling the attenuator on the basis of the error signal.

2. A method of operating a variable optical attenuator so as to maintain a target optical power ratio in response to any disturbances; wherein the method includes producing an error signal indicative of the product of the reciprocal of Pin and the difference between Pout and the product of Pin and the target output/input power ratio; and controlling the attenuator on the basis of the error signal.

3. A method according to claim 1, wherein error signals are produced periodically and the attenuator is controlled on the basis of the error signals according to proportional-integral control.

4. A method according to claim 2, wherein error signals are produced periodically and the attenuator is controlled on the basis of the error signals according to proportional-integral control.

5. A method according to claim 1, wherein the error signal is produced by digital signal processing.

6. A method according to claim 2, wherein the error signal is produced by digital signal processing.

7. A system for automatically operating a variable optical attenuator; including an output photodiode optically coupled to the optical output of the VOA, and optionally an input photodiode coupled to the optical output of the VOA; and circuitry for producing on the basis of the outputs from the photodiodes an error signal indicative of the product of the reciprocal of the actual input power or actual output power and the difference between the actual output power and the target output power, and controlling the attenuator on the basis of the error signal.

8. A system for automatically operating a variable optical attenuator so as to maintain a target optical power ratio in response to any disturbances; including first and second photodiodes coupled to the optical input and outputs of the variable optical attenuator; and circuitry for producing on the basis of the outputs from the photodiodes an error signal indicative of the product of the reciprocal of Pin and the difference between Pout and the product of Pin and the target output/input power ratio, and controlling the attenuator on the basis of the error signal.

9. A system according to claim 8, wherein the circuitry includes one or more elements for (i) producing digital signals A and B equally indicative of Pout and Pin; and (ii) processing the digital signals A and B according to the following algorithm:
[A−(B×Target Output/Input Power Ratio)]/B
to produce said error signal.

10. A system according to claim 9, wherein said one or more elements include a digital signal processor for at least carrying out step (ii).

11. A system according to claim 8, wherein the circuitry produces error signals periodically and the attenuator is controlled on the basis of the error signals according to proportion-integral (PI) control.

12. A system according to claim 9, wherein the circuitry produces error signals periodically and the attenuator is controlled on the basis of the error signals according to proportion-integral (PI) control.

13. A system according to claim 10, wherein the circuitry produces error signals periodically and the attenuator is controlled on the basis of the error signals according to proportion-integral (PI) control.

14. A method of operating a variable optical attenuator so as to maintain a target optical power ratio in response to any disturbances; wherein the method includes producing an error signal dependent on the difference between the actual optical power ratio and the target optical power ratio but independent of the absolute value of the input power; and controlling the attenuator on the basis of the error signal.

15. A method according to claim 14, wherein the error signal is produced without using logarithmic functions.

16. A system for operating a variable optical attenuator; including photodiodes for receiving a portion of the optical input and output, respectively, of the variable optical attenuator; switchable gain transimpedance amplifiers for receiving the output signals from the photodiodes; and circuitry for controlling the attenuator on the basis of the output signals from the transimpedance amplifiers; wherein said circuitry also automatically controls the gain of the switchable gain transimpedance amplifiers according to the output signals from the transimpedance amplifiers.

17. A system according to claim 16, wherein the circuitry includes a microprocessor.
